(19) United States
(12) Patent Application Publication
(10) Pub. No.: US 2016/0012461 A1
(43) Pub. Date: Jan. 14, 2016

(54) SYSTEMS AND METHODS FOR PROVIDING TRANSPORTATION DISCOUNTS IN SHARED RIDES

(71) Applicants: Sunil Paul, San Francisco, CA (US); Jahan Khanna, San Francisco, CA (US); Robert Wong, Burlingame, CA (US); Robert Moran, San Francisco, CA (US)

(72) Inventors: Sunil Paul, San Francisco, CA (US); Jahan Khanna, San Francisco, CA (US); Robert Wong, Burlingame, CA (US); Robert Moran, San Francisco, CA (US)

(21) Appl. No.: 14/794,425

(22) Filed: Jul. 8, 2015

Related U.S. Application Data
(60) Provisional application No. 62/023,307, filed on Jul. 11, 2014.
(60) Provisional application No. 62/025,129, filed on Jul. 16, 2014.
(60) Provisional application No. 62/037,445, filed on Aug. 14, 2014.

(51) Int. Cl. G06Q 30/02; G06Q 10/02

(52) U.S. Cl. CPC G06Q 30/0207; G06Q 10/02

(57) ABSTRACT

Systems and methods for providing discounts for shared transportation are provided. A transportation server receives, from a client device of a first user, a first request for a shared transportation service. The transportation server receives, from a client device of a second user, a second request to join the shared transportation service. The transportation server calculates a first price for the first user for the shared transportation service based on at least a portion of a shared transportation service trip. The transportation server calculates a second price for the second user for the shared transportation service trip based on at least the portion of a shared transportation service trip.

### CROSS-REFERENCE TO RELATED APPLICATIONS

This patent application claims the benefit of U.S. Provisional Patent Application Ser. No. 62/023,307, filed on Jul. 11, 2014 and entitled “SYSTEMS AND METHODS FOR DETERMINING SHARED TRANSPORTATION SERVICES” which is incorporated by reference in its entirety.

This patent application claims the benefit of U.S. Provisional Patent Application Ser. No. 62/025,129, filed on Jul. 16, 2014 and entitled “SYSTEMS AND METHODS FOR QUEUEING TRANSPORTATION SERVICES” which is incorporated by reference in its entirety.

This patent application claims the benefit of U.S. Provisional Application Ser. No. 62/037,445, filed on Aug. 14, 2014 and entitled “SYSTEMS AND METHODS FOR IMPROVED SHARED TRANSPORTATION SERVICES AND IMPROVED QUEUED TRANSPORTATION SERVICES” which is incorporated by reference in its entirety.

### TECHNICAL FIELD

The present disclosure generally relates to transportation services and, more specifically, to systems and methods for providing transportation discounts in shared rides.

### BRIEF DESCRIPTION OF THE DRAWINGS

Some embodiments are illustrated by way of example and not of limitation in the figures of the accompanying drawings.

FIG. 1 is a schematic diagram showing an example of a system for providing a transportation marketplace, according to some embodiments;

FIG. 2 is a block diagram showing example components of a transportation server, according to some embodiments;

FIG. 3 is a block diagram showing example components of a client device, according to some embodiments;

FIG. 4 is a flowchart showing an example method of providing discounts in exchange for a shared transportation service, according to some embodiments; and

FIG. 5 is a block diagram of a machine in the example form of a computer system within which a set of instructions, for causing the machine to perform any one or more of the methodologies discussed herein, may be executed, according to some embodiments.

### DETAILED DESCRIPTION

Example systems and methods for providing transportation discounts for multiple passengers of a shared transportation service are described. In the following description, for purposes of explanation, numerous specific details are set forth in order to provide a thorough understanding of example embodiments. It will be evident, however, to one skilled in the art that the present technology may be practiced without these specific details.

A transportation server may provide an online environment in which drivers and passengers may connect with one another for shared transportation services. The transportation server determines discount payments required by each passenger of a shared transportation service trip. In some embodiments, discount payment amounts required by each passenger may be similar. In other embodiments, discount payment amounts required by each passenger may be different. In some embodiments, a payment may be offered to a driver in exchange for the driver accepting an additional passenger for the shared transportation service trip.

A first passenger may use a software application on the first passenger's computing device to send a request for a shared transportation service. In some embodiments, the software application displays a discount price the first passenger will be required to pay for the shared transportation service.

In response to the request for the shared transportation service sent from the first passenger's computing device, the transportation server sends a verification message to the first passenger's computing device. The purpose of the verification message is to verify whether the first passenger intended to request the shared transportation service—as opposed to a non-shared transportation service. The verification message provides the first passenger an opportunity to opt-out of the requested shared transportation service.

If the transportation server receives a response to the verification message from the first passenger's computing device, the transportation server cancels the first passenger's request for the shared transportation service. If the transportation server does not receive a response to the verification message from the first passenger's computing device within a period of time, the transportation server notifies one or more drivers of the request for the shared transportation service through a software application on each drivers' respective computing device, and a driver may choose to perform the shared transportation service which will include the first passenger and one or more additional passengers.

A second passenger may use the software application on the second passenger's computing device to view a representation of the shared transportation service established between a driver and the first passenger. In some embodiments, the software application displays a discount price the second passenger will be required to pay for joining the shared transportation service established between the driver and the first passenger.

The second passenger may use the software application on the second passenger's computing device to send a request to join the shared transportation service established between the first passenger and the driver. The driver may choose to accept the second passenger's request to join the shared transportation service via the driver's computing device. In some embodiments, the transportation server sends to the driver's computing device a payment amount to be paid to the driver in exchange for accepting the second passenger's request to join the shared transportation service. The driver's computing device sends data to the transportation server representative of the driver's acceptance of the second passenger's request to join the shared transportation service.

The transportation server establishes the shared transportation service between the driver, the first passenger and the second passenger. In one embodiment, the transportation server sends shared transportation service data to the first passenger's computing device and the second passenger's computing device. The shared transportation service data sent from the transportation server to the first passenger's computing device can be based on the first passenger's desired starting location and desired destination location and can also be based on the second passenger's desired starting location and desired destination location. In some embodiments, in order to be respectful of the second passenger's privacy, the shared transportation service data based on the second passenger's desired starting location and desired destination that is sent to the first passenger's computing device may be based on a result of the transportation server modifying (or obscuring) the second passenger's desired starting location and desired destination. For example, the transportation server sends a zip code or cross-streets associated with the second passenger's desired destination for display on the first passenger's computing device.

The shared transportation service data sent from the transportation server to the second passenger's computing device can be based on the second passenger's desired starting location and desired destination location and can also be based on the first passenger's desired starting location and desired destination location. In some embodiments, in order to be respectful of the first passenger's privacy, the shared transportation service data based on the first passenger's desired starting location and desired destination that is sent to the second passenger's computing device may be based on a result of the transportation server modifying (or obscuring) the first passenger's desired starting location and desired destination. For example, the transportation server sends a zip code or cross-streets associated with the first passenger's desired destination for display on the second passenger's computing device.

By establishing the shared transportation service between the driver, the first passenger and the second passenger, the transportation server defines a shared transportation service trip (hereinafter “shared trip”) to be performed by the driver. The shared trip will transport the first passenger to a first destination desired by the first passenger (hereinafter “First Destination”). The shared trip will also transport the second passenger to a second destination desired by the second passenger (hereinafter “Second Destination”). In addition, the first passenger and the second passenger will accompany each other during at least a portion of the shared trip.

In some embodiments, the First Destination and the Second Destination are the same location. In other embodiments, the First Destination and the Second Destination are not the same location. In some embodiments, the first passenger and the second passenger begin the shared trip from the same location. In other embodiments, the first passenger and the second passenger begin the shared trip from different locations.

In some embodiments, the driver performing the shared trip logs shared trip events by entering at least one input into the driver's computing device. For example, the driver enters a shared trip event into the driver's computing device each time a respective passenger begins and ends the shared trip. The driver's computing device sends data representative of each logged shared trip event to the transportation server. In some embodiments, the transportation server uses the data representative of a shared trip event to initiate fulfillment of a discount payment from a passenger of the shared trip.

The transportation server may facilitate payment between the driver and the passengers of a shared trip. In particular, the transportation server determines discount payments required from both the first and second passengers in exchange for the shared trip. For example, the first passenger's discount payment determined by the transportation server may be less than a payment determined by the transportation server for a non-shared transportation service that transports the first passenger to the First Destination. In addition, the second passenger's discount payment may be less than a payment determined by the transportation server for a non-shared transportation service that transports the second passenger to the Second Destination.

In some embodiments, an amount of a first discount payment required by the first passenger in exchange for the shared trip may be different than an amount of a second discount payment required by the second passenger in exchange for the shared trip. In one embodiment, the difference in the amounts of the first and second discount payments is based at least on a detour portion(s) of the shared trip the first passenger had to experience due to the second passenger's desired starting location and/or desired destination. In other embodiments, the difference in amounts of the first and second discount payments is be based at least on a detour portion(s) of the shared trip the second passenger had to experience due to the first passenger's desired starting location and/or desired destination. It is understood that a detour portion of a shared trip is a portion of the shared trip that a passenger would not have had to experience but for the starting location and/or destination location of another passenger of the shared trip.

In other embodiments, the difference in the amounts of the first and second discount payments is based at least on a portion of the shared trip during which either the first passenger or the second passenger is unaccompanied. In other embodiments, the difference in the amounts of the first and second discount payments is based at least on a portion of the shared trip during which the first and the second passenger accompany each other during the shared trip.

In some embodiments, the difference in the amounts of the first and second discount payments is based at least on a portion of the shared trip during which the first passenger accompanies the second passenger due to the second passenger's desired destination (i.e. the Second Destination) being different than the first passenger's desired destination (i.e. the First Destination). In other embodiments, the difference in the amounts of the first and second discount payments is based at least on a portion of the shared trip during which the second passenger accompanies the first passenger due to the first passenger's desired destination (i.e. the First Destination) being different than the second passenger's desired destination (i.e. the Second Destination).

In some embodiments, the difference in the amounts of the first and second discount payments is based at least on a portion of the shared trip during which the first passenger is unaccompanied due to the second passenger's desired destination (i.e. the Second Destination) being different than the first passenger's desired destination (i.e. the First Destination). In other embodiments, the difference in the amounts of the first and second discount payments is based at least on a portion of the shared trip during which the second passenger is unaccompanied due to the first passenger's desired destination (i.e. the First Destination) being different than the second passenger's desired destination (i.e. the Second Destination).

In some embodiments, the difference in the amounts of the first and second discount payments is based at least on a portion of the shared trip during which the first passenger is unaccompanied due to the second passenger's starting location being different than the first passenger's starting location. In other embodiments, the difference in the amounts of the first and second discount payments is based at least on a portion of the shared trip during which the second passenger is unaccompanied due to the first passenger's starting location being different than the second passenger's starting location.

In other embodiments, the difference in the amounts of the first and second discount payments may be based at least on a portion of the shared trip required due to the first passenger's starting location and/or desired destination. The difference in the amounts of the first and second discount payments may be based at least on a portion of the shared trip required due to the second passenger's starting location and/or desired destination.

It is understood that shared transportation services that define a shared trip amongst a plurality of passengers may be provided to the passengers at a discount or at a premium rate, which may be automatically and dynamically based on any suitable characteristics and/or factors associated with the particular shared transportation service requested. For example, a particular request for shared transportation may be fulfilled at a discounted rate based on a location of a driver and/or a location of a passenger near the time of the shared transportation request, based on a destination associated with the shared transportation request, and the like. Providing adjusted pricing may create a capability to discount or otherwise modify the characteristics of a shared transportation service trip based on identifying a location relating to a driver and/or passenger (e.g., a starting location, a destination location, etc.) as a hotspot location that may be associated with the adjusted pricing. A hotspot location may be a geographical location of any suitable size (e.g., a particular radius around a city center, a landmark, a neighborhood, etc.) that is associated with adjusted pricing (e.g., a discount) adjustable based on characteristics of a shared transportation request.

The transportation server may determine whether a requested shared transportation service is associated with a hotspot location (e.g., travels through a hotspot, travels within a hotspot, etc.) based on any suitable factors, such as the particular starting location and the destination location requested by the passenger, a passenger's location near the time of the request (e.g., using a service for detecting a location of a passenger's computing device, such as global positioning system (GPS)), a destination location estimated based on a passenger's calendar entry or any other suitable predictive technology, a destination location determined by a driver based on any variety and/or combination of user inputs (e.g., advice from a passenger, an intermediate stop requested and/or required by a driver and/or passenger, a driver indicating the end of a trip, etc.), and the like.

A hotspot location may be established in any suitable manner, such as by a sponsor responsible for a monetary discount associated with the hotspot location, a driver, a passenger, the transportation server, an entity associated with a pickup and/or drop-off location, a crowd-sourced decision-making manner of determining a hotspot location (e.g., through a voting system), an entity in a rewards program who is rewarded by being given the ability to set a particular hotspot location (e.g., which in some embodiments may be automated), a third-party associated with any of the above, and the like.

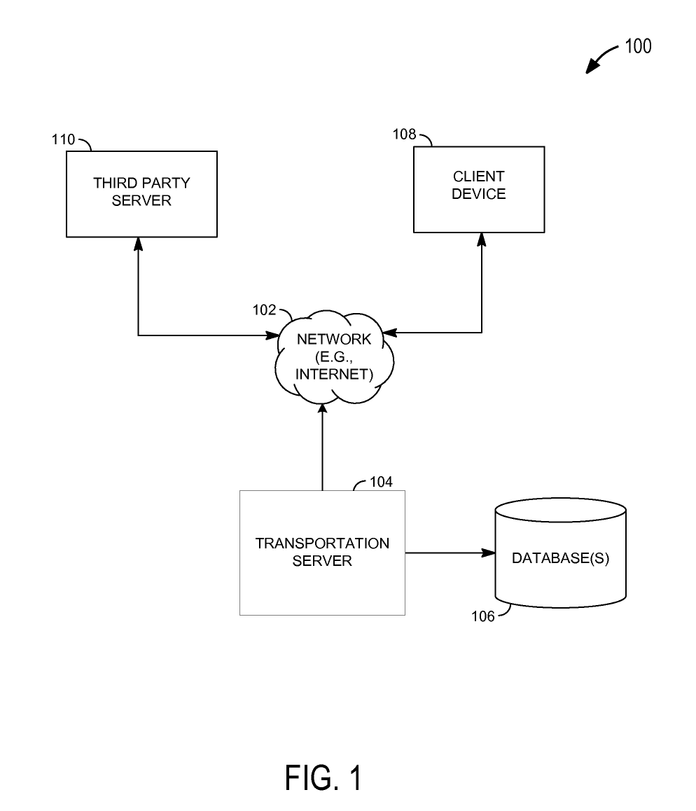

FIG. 1 is a schematic diagram showing an example of a system 100 for providing a transportation marketplace. The system 100 includes a transportation server 104, one or more client devices 108, and a third party server 110. The components of the system 100 are connected directly or over a network 102, which may be any suitable network. In various embodiments, one or more portions of the network 102 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The transportation server 104 may include a network-addressable computing system that may facilitate communication between drivers and passengers and may obtain and utilize data relevant to drivers and/or passengers stored in the database(s) 106.

The client device 108 may be any suitable computing device that may be used by a driver and/or a passenger to communicate with one another, such as a smart phone, a personal digital assistant (PDA), a mobile phone, a personal computer, a laptop, a computing tablet, or any other device suitable for communication.

The third party server 110 may be any server that may be accessed by the transportation server 104 and/or the client device 108 to obtain information relevant to transportation services (e.g., public transportation, location-based services, etc.).

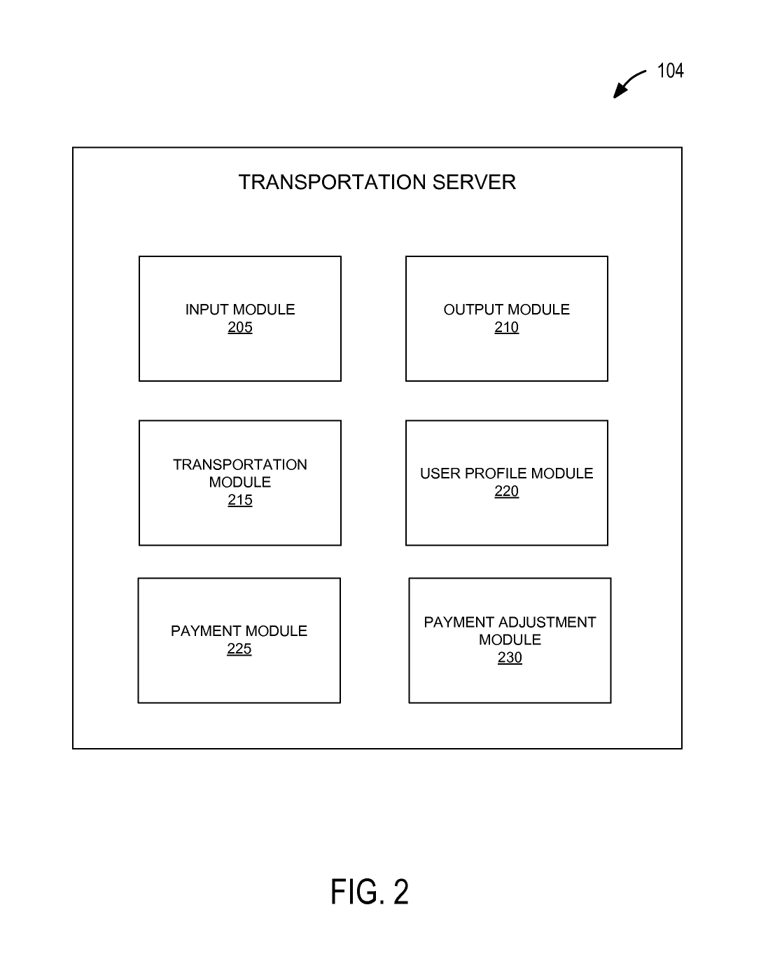

FIG. 2 is a block diagram showing example components of a transportation server 104. The transportation server 104 includes an input module 205, an output module 210, a transportation module 215, a user profile module 220, a payment module 225, and a payment adjustment module 230.

The input module 205 may be a hardware-implemented module which receives and processes any inputs from one or more components of system 100 of FIG. 1 (e.g., one or more client devices 108, third party server 110, etc.). The inputs may include requests related to transportation, payment information, and the like. For example, the inputs may be related to request for shared transportation.

The output module 210 may be a hardware-implemented module which sends any outputs to one or more components of system 100 of FIG. 1 (e.g., one or more client devices 108, third party server 110, etc.). The outputs may include information about available drivers, passengers requesting transportation, and the like. For example, the outputs may be related to one or more passengers that have requested shared transportation.

The transportation module 215 may be a hardware-implemented module which manages, facilitates, and controls transportation requests (such as shared transportation requests) from passengers and/or drivers. For example, when a request for shared transportation is received from one or more passengers, the transportation module 215 may determine and generate a list of drivers available to fulfill the request.

The user profile module 220 may be a hardware-implemented module which manages, controls, stores, and accesses information associated with drivers and/or passengers. The information may be stored in and accessed from the database(s) 106 shown in FIG. 1. The information managed by the user profile module 220 may include any information associated with a driver(s) and/or passenger(s), such as preferences, vehicle information, background information of a driver, ratings of drivers and/or passengers, payment information of drivers and/or passengers, and the like.

The payment module 225 may be a hardware-implemented module which manages, facilitates, and controls payments between drivers and passengers. The payment module 225 may also determine suggested prices associated with shared transportation requests based on the characteristics of the request (e.g., distance to be traveled, etc.).

The payment adjustment module 230 may be a hardware-implemented module which manages, facilitates, determines, identifies, and calculates adjustment payments (e.g., a discount, a premium, etc.) based on characteristics of the shared transportation service requested by one or more passengers.

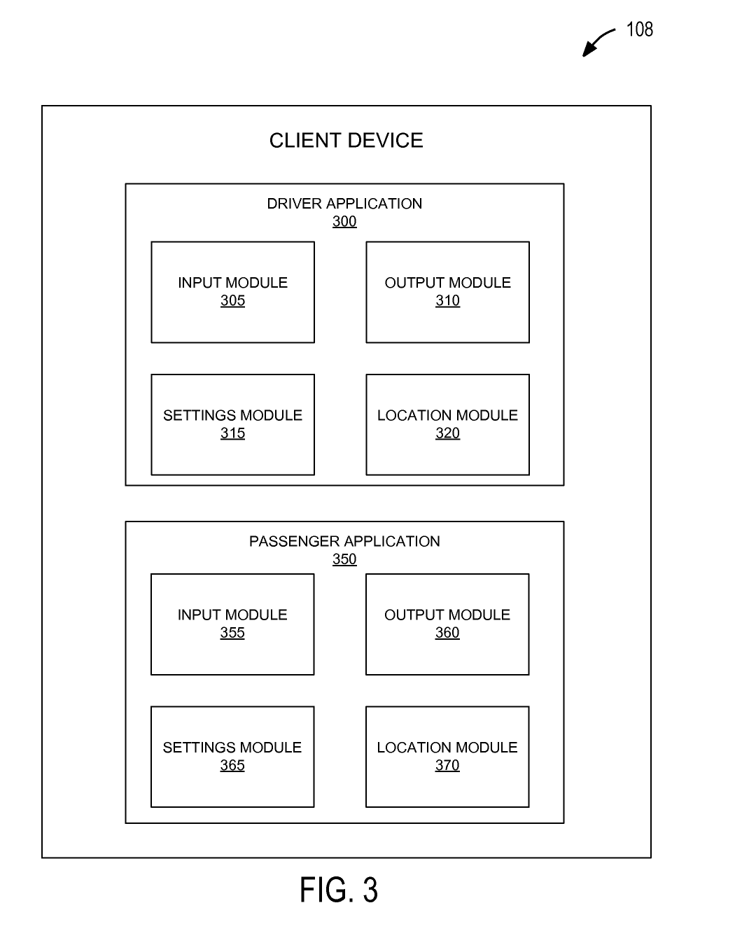

FIG. 3 is a block diagram showing example components of a client device 108. The client device may be a computing device of a driver(s) and/or a passenger(s) and may include a driver application 300 and/or a passenger application 350.

The driver application 300 may be a software application associated with the transportation server 104 of FIGS. 1-2. The driver application may include an input module 305, an output module 310, a settings module 315, and a location module 320.

The input module 305 may be a hardware-implemented module that may receive and process any inputs from a driver, including inputs related to responses to shared transportation requests from one or more passengers, inputs related to preferences of the driver, inputs related to events during a particular shared transportation service trip, and the like.

The output module 310 may be a hardware-implemented module that may send any outputs to one or more components of system 100 of FIG. 1 (e.g., other client devices 108, third party server 110, transportation server 104, etc.). The outputs may include responses to shared transportation service requests, location of the client device 108, and the like.

The settings module 315 may be a hardware-implemented module that may manage, store, and access settings indicated by a driver, such as starting location, destination location, price, a rating of a passenger, a casual carpool preference, and the like. It is understood that a starting location can be a passenger's desired pick-up location and a destination location can be a passenger's desired drop-off location.

The location module 320 may be a hardware-implemented module that may determine a location of the client device 108. The location module 320 may determine location in any suitable manner (e.g., using a third party server 110, GPS capabilities on the client device 108, etc.).

The passenger application 350 may be a software application associated with the transportation server 104 of FIGS. 1-2. The passenger application may include an input module 355, an output module 360, a settings module 365, and a location module 370.

The input module 355 may be a hardware-implemented module that may receive and process any inputs from a passenger, including inputs related to a shared transportation service request, inputs related to preferences of the passenger, and the like.

The output module 360 may be a hardware-implemented module that may send any outputs to one or more components of system 100 of FIG. 1 (e.g., other client devices 108, third party server 110, transportation server 104, etc.). The outputs may include shared transportation service requests, location of the client device 108, and the like.

The settings module 365 may be a hardware-implemented module that may manage, store, and access settings indicated by a passenger, such as a starting location, a destination location, a price preference, a driver rating, a driver response rate, a casual carpooling preference, a preferred estimated time of arrival, and the like.

The location module 370 may be a hardware-implemented module that may determine a location of the client device 108. The location module 320 may determine location in any suitable manner (e.g., using a third party server 110, GPS capabilities on the client device 108, etc.).

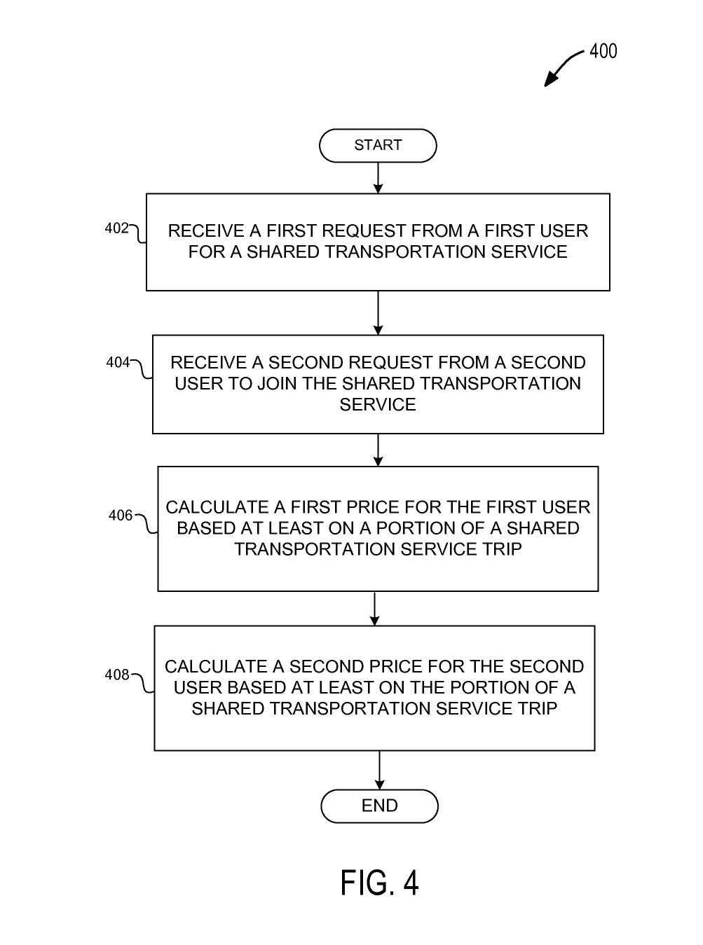

FIG. 4 is a flowchart showing an example method 400 of providing discounts for shared transportation. The operations of FIG. 4 may be performed by components of the transportation server 104 of FIG. 2.

In operation 402, the hardware-implemented input module 205 receives a first request from a first user for a shared transportation service. For example, the first request may be sent from a computing device associated with a first passenger.

In operation 404, the hardware-implemented input module 205 receives a second request from a second user to join the shared transportation service. For example, the second request may be sent from a computing device associated with a second passenger. Based on the first request and the second request, the transportation server 104 defines a shared trip between the first user and the second user.

In operation 406, the hardware-implemented payment adjustment module 230 calculates a first price for the first user based at least on a portion of a shared transportation service trip.

In operation 408, the hardware-implemented payment adjustment module 230 calculates a second price for the second user based at least on the portion of a shared transportation service trip. In one embodiment, the first price may be different than the second price due to the first user or the second user being unaccompanied during the portion of the shared transportation service trip.

It is understood that, in various embodiments, any and/or all of the modules of the transportation server 104 can be involved in performing operations 404, 406 and 408.

In some embodiments, a request for a shared transportation service may relate to a hotspot location associated with a particular characteristic, and the request may be provided to one or more drivers relevant to the particular characteristic. For example, the request may related to an estimated time of arrival, a rating of a driver, a type of driver, a type of vehicle, and the like, and the request may be sent to drivers associated with one or more of these characteristics.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

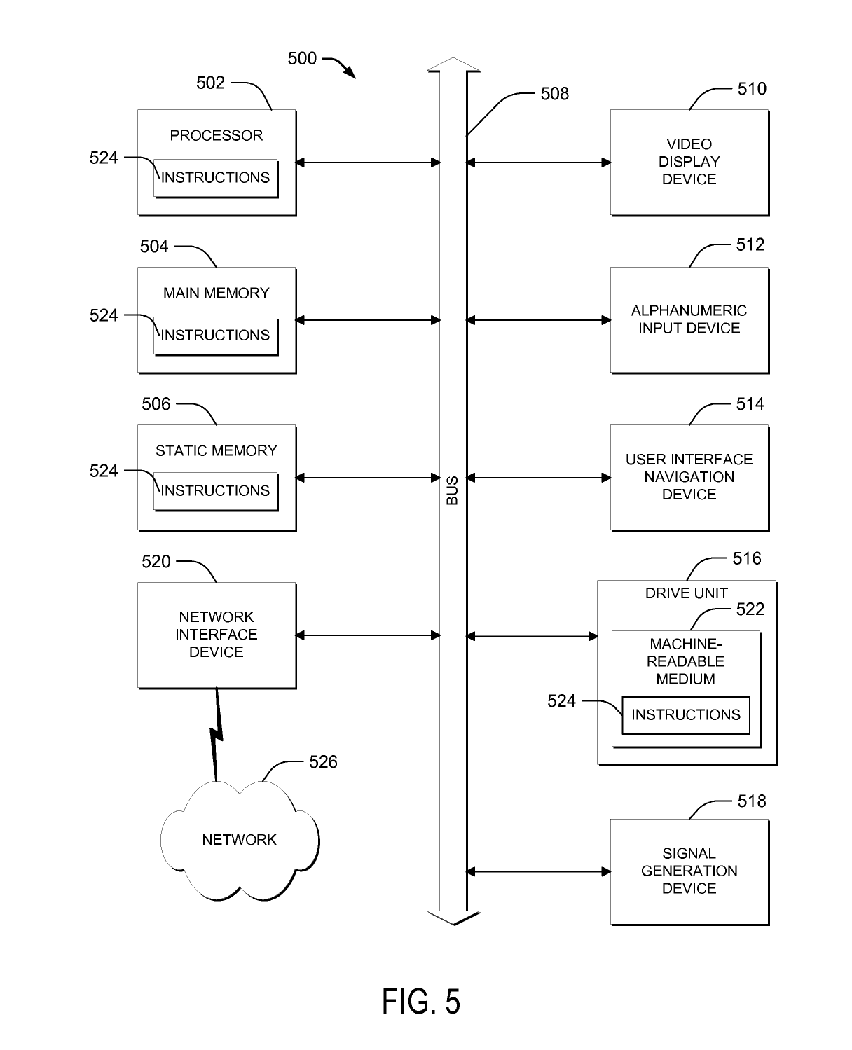

FIG. 5 is a block diagram of a machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes a processor 502 (e.g., a central processing unit (CPU), a graphics processing unit (GPU) or both), a main memory 504, and a static memory 506, which communicate with each other via a bus 508. Computer system 500 may further include a video display device 510 (e.g., a liquid crystal display (LCD) or a cathode ray tube (CRT)). Computer system 500 also includes an alphanumeric input device 512 (e.g., a keyboard), a user interface (UI) navigation device 514 (e.g., a mouse or touch sensitive display), a disk drive unit 516, a signal generation device 518 (e.g., a speaker) and a network interface device 520.

Disk drive unit 516 includes a machine-readable medium 522 on which is stored one or more sets of instructions and data structures (e.g., software) 524 embodying or utilized by any one or more of the methodologies or functions described herein. Instructions 524 may also reside, completely or at least partially, within main memory 504, within static memory 506, and/or within processor 502 during execution thereof by computer system 500, main memory 504 and processor 502 also constituting machine-readable media.

While machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 524 may further be transmitted or received over a communications network 526 using a transmission medium. Instructions 524 may be transmitted using network interface device 520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, from a client device of a first user, a first request for a shared transportation service;
receiving, from a client device of a second user, a second request to join the shared transportation service;
calculating, at a server, a first price for the first user for the shared transportation service based on at least a portion of a shared transportation service trip; and
calculating, at the server, a second price for the second user for the shared transportation service trip based on at least the portion of a shared transportation service trip.

2. The method of claim 1, wherein the first price is different than the second price due to one of the first user and the second user being unaccompanied during at least the portion of the shared transportation service trip.

3. The method of claim 1, wherein the first price is equal to the second price due to the first user and the second user accompanying each other during at least the portion of the shared transportation service trip.

4. The method of claim 1, wherein the first price is less than a price for the first user for a first non-shared transportation service trip to a desired destination of the first user; and
wherein the second price is less than a price for the second user for a second non-shared transportation service trip to a desired destination of the second user.

5. The method of claim 1, further comprising:
defining, at the server, the shared transportation service trip based on the first request and the second request.

6. The method of claim 1, further comprising:
determining, at the server, a payment amount for a driver of the shared transportation service trip in exchange for receiving an acceptance from the driver of the second request to join the shared transportation service; and
sending, from the server, display data to a client device of the driver, wherein the display data causes the client device of the driver to display the payment amount.

7. A machine-readable storage medium storing instructions which, when executed by one or more processors, cause the one or more processors to perform operations comprising:
receiving, from a client device of a first user, a first request for a shared transportation service;
receiving, from a client device of a second user, a second request to join the shared transportation service;
calculating, at a server, a first price for the first user for the shared transportation service based on at least a portion of a shared transportation service trip; and
calculating, at the server, a second price for the second user for the shared transportation service trip based on at least the portion of a shared transportation service trip.

8. The machine-readable storage medium of claim 7, wherein the first price is different than the second price due to one of the first user and the second user being unaccompanied during at least the portion of the shared transportation service trip.

9. The machine-readable storage medium of claim 7, wherein the first price is equal to the second price due to the first user and the second user accompanying each other during at least the portion of the shared transportation service trip.

10. The machine-readable storage medium of claim 7, wherein the first price is less than a price for the first user for a first non-shared transportation service trip to a desired destination of the first user; and
wherein the second price is less than a price for the second user for a second non-shared transportation service trip to a desired destination of the second user.

11. The machine-readable storage medium of claim 7, further comprising:
defining, at the server, the shared transportation service trip based on the first request and the second request.

12. The machine-readable storage medium of claim 7, further comprising:
determining, at the server, a payment amount for a driver of the shared transportation service trip in exchange for receiving an acceptance from the driver of the second request to join the shared transportation service; and
sending, from the server, display data to a client device of the driver, wherein the display data causes the client device of the driver to display the payment amount.

13. A system comprising:
a hardware-implemented input module configured to:
receive, from a client device of a first user, a first request for a shared transportation service; and
receive, from a client device of a second user, a second request to join the shared transportation service; and
a hardware-implemented payment adjustment module configured to:
calculate a first price for the first user for the shared transportation service based on at least a portion of a shared transportation service trip; and
calculate a second price for the second user for the shared transportation service trip based on at least the portion of a shared transportation service trip.

14. The system of claim 13, wherein the first price is different than the second price due to one of the first user and the second user being unaccompanied during at least the portion of the shared transportation service trip.

15. The system of claim 13, wherein the first price is equal to the second price due to the first user and the second user accompanying each other during at least the portion of the shared transportation service trip.

16. The system of claim 13, wherein the first price is less than a price for the first user for a first non-shared transportation service trip to a desired destination of the first user; and
wherein the second price is less than a price for the second user for a second non-shared transportation service trip to a desired destination of the second user.

17. The system of claim 13, further comprising:
defining, at the server, the shared transportation service trip based on the first request and the second request.

18. The system of claim 13, further comprising:
determining, at the server, a payment amount for a driver of the shared transportation service trip in exchange for receiving an acceptance from the driver of the second request to join the shared transportation service; and
sending, from the server, display data to a client device of the driver, wherein the display data causes the client device of the driver to display the payment amount.
